(19) United States
(12) Patent Application Publication
(10) Pub. No.: US 2014/0224584 A1
(43) Pub. Date: Aug. 14, 2014

(54) RAPID ESCAPE EXIT FOR HIGH BUILDING

(71) Applicant: Ashwan Murdhi B Aldosari, Beijing (CN)

(72) Inventor: Ashwan Murdhi B Aldosari, Beijing (CN)

(21) Appl. No.: 14/342,789

(22) PCT Filed: Aug. 15, 2012
(86) PCT No.: PCT/CN2012/080175

§ 371 Date: Mar. 5, 2014

(30) Foreign Application Priority Data
Sep. 6, 2011 (GC) GC-2011-19222

(51) Int. Cl. A62B 1/20

(52) U.S. Cl. CPC A62B 1/20
USPC 182/18; 182/48

(57) ABSTRACT

The present invention discloses a rapid escape exit for a high building. The rapid escape exit is applied to an evacuation process. A transit point is set in each floor by accurately calculating according to an equation of Ashwan evacuation rule: A=B+M, wherein A is a floor level from which one is going to descend, B is a floor level to which one is going to reach, and M is the number of groups for the slideway in the building and labeled as M1, M2, . . . Mn. People may quit from an escape exit and then immediately enter another escape exit. Therefore, with the rapid escape exit, i.e., the fifth mode of Ashwan exit, it is possible to reduce the area used for installing slideway on the sideface of the building, and to reduce the risk of dizziness and imbalances which are accumulated during drop from a high building.

### CROSS-REFERENCE TO RELATED APPLICATION

This application is the U.S. national phase of International Application No. PCT/CN2012/080175, filed on Aug. 15, 2012, which claims the priority benefit a Patent which is application No. GC-2011-19222, filed on Sep. 6, 2011. The entire contents of which is hereby incorporated by reference.

### BACKGROUND OF THE INVENTION

### Field of the Invention

The present invention relates to a safety system, and in particular to a rapid escape exit for a high building. This rapid escape exit is especially applicable to an evacuation process in some place where many people gather; while some people need help from others to reach a safety exit and also need care from others to pass the safety exit (otherwise they may find difficulty in passing the existing emergency exit).

### Background of the Invention

It is required to add safety exits in a multi-storey building which accommodates a lot of people, such as a hospital, school, hotel, and airport. The disabled may live in a floor apart from the first floor of a multi-storey building. For example, the disabled may use a wheel chair in some place. Due to the fact of being disabled, it is difficult for them to pass the safety exit, and also it is not easy for them to reach the exit. In the school, especially a nursery school, primary school, and secondary school, the schoolchildren are too young to realize the seriousness. Besides, they are too large in number for the teachers to care for, so that it is hard for each teacher to evacuate more than two schoolchildren for each time. In the hospital, there are patients who are too bad in conditions to move or keep balance, and the number of patients are much larger than that of the medical staff. Furthermore, since most of the medical staff is female, their ability may be restricted in such a situation. To conclude, those exits in the existing buildings are far away from satisfactory in term of evacuating the crowd rapidly. This suggests that we should find alternative solution to avoid such disasters. In the prior art, people escape from the stairs (fire safety door). The stream of people crowds hastily in the stairs. In this situation, it may lead to mass casualties and mental stress, and the people may jump from the window, which causes death or at least disability. With the first generation of technical solution of the inventors (a rapid escape exit), the above problems have basically been solved, since the use of this technical solution can satisfactorily realize a rapid and fluent evacuation. In the first generation of technical solution (a rapid escape exit), people are allowed to pass the exit regardless of their age. This invention has got a certificate authentication under an industrial model certificate No. 559 on Dec. 11, 2007 from King Abdul-Aziz City for Science and Technology (KACST). In addition, this invention has been registered in Gulf Cooperation Council Patent Office under OP/B/2005/5211. This invention can be applied to a building generally with not more than ten floors. However, in case that the first generation of technical solution (a rapid escape exit) is applied to a high building with more than ten floors and skyscrapers over 200 floors, assuming the slideway is installed inside the building and is divided into different groups, and each group is composed of three slideways, it is required that the building should have an outer surface perimeter over 200 meters, and should cover an area of 600 m² around the building. Generally, less slideway leads to better sliding, and vice versa. Therefore, the designer finds it urgent to simplify the evacuation process for a huge building, and it is necessary to apply the rapid escape exit of the second generation. However, in these buildings, it is required to be applied in a different manner. That is, a transit point is set in each floor by accurately calculating according to an equation A=B+M, wherein A is a floor level from which one is going to descend, B is a floor level to which one is going to reach, and M is the number of groups for the slideway in the building (labeled as the first, second, etc.). Detailed discussion will be presented for the application of the invention in the following detailed description of the invention.

### BRIEF SUMMARY OF THE INVENTION

It is an object of the invention to solve problems during an evacuation process in a high building which results from the fact the rapid escape exit can not be applied to the high building in the prior art. This means that a technical solution is needed to overcome the drawbacks in the prior art.

To obtain the above object, the technical solution of the invention is to design a rapid escape exit for a high building, characterized in that, said escape exit is arranged between one floor and another floor inside and/or outside the high building, and between a floor and the ground, in said high building said escape exit is divided into several groups, in each group of escape exit is provided at least one spiral slideway, one end of said spiral slideway is provided at the escape exit of an escape starting floor, and the other end of said spiral slideway is provided at the escape exit of an intermediate floor during escape, said spiral slideway crosses several floors in the high building, several spiral slideways in said several groups make it possible for all people in the high building to escape in a relay evacuation manner, said relay evacuation is an evacuation in which the escape people come out from the escape exit of a spiral slideway, then enter the escape entrance of another spiral slideway, until they finally reach the ground.

The internal surface of said spiral slideway is a smooth surface, and the cross-section of said spiral slideway is circular or elliptical.

An exit end of said spiral slideway has a length which is parallel with the ground.

Said escape exit arranged outside the high building is supported by a ladder stand, and said ladder stand is provided with a platform and fences at the exit and entrance of each spiral slideway.

A switch controlled escape door is arranged at the exit and entrance of each spiral slideway, and said escape door is connected with a controller.

Said controller drives said escape door with a hydraulic driving device, and said escape door is further provided with a magnetically controlled lock.

An emergency lamp and an alarm device are further arranged inside said spiral slideway and at the exit and entrance.

Said controller, emergency lamp, and alarm device are powered by a storage battery or an uninterruptible power supply.

The present invention relates to the second generation of rapid escape exit, namely, the fifth mode of Ashwan exit. In the fifth mode rapid escape exit, a rule of accurately calculating the transit point is applied, which helps to coordinate evacuation in a high building. The rule is named Ashwan evacuation rule, which defines B=A−M, wherein A is a floor level from which one is going to descend through the slideway (i.e., the start of escape), B is a floor level to which one is going to reach from a relatively higher floor (i.e., the destination point). During each period of the evacuation process, the next rule A>B is applied. This may be repeated for several times in the high building. After being reached from the point A in the first period, the destination point B may also be calculated from the point A during the second period after which may be reached. M is the number of groups for the slideway, wherein M={m₁+m₂+m₃ . . . +mₙ}, and m₁ is the first slideway group, m₂ is the second slideway group, m₃ is the third slideway group, and so on.

In each group, the number of slideways is associated with the diameter of the longitudinal slideway (the slideway), and for example the number of the slideway is in inverse proportion to the diameter of the slideway. The number of slideways is associated with the height of a signal floor, and for example the number of the slideway is in inverse proportion to the number of floor. As we found, the fifth mode rapid escape exit, namely the Ashwan exit, intends to fulfill the task of evacuating all people in the high building. It automatically operates according to the detection of smoke by a smoke detector, and then sends a signal to a controller. The controller connects all portions of the present system to the control room, which sends a plurality of signals to an alarm device to alarm the people, sends a signal which controls a signal lamp to emit uneven red light to guide people gather from the inside and outside to the emergency escape exit, sends a signal to an emergency lamp which provides a backup battery to respond to the possible power outage, and sends a signal to magnetic lock to open the escape door. When the lock is unlocked, the door is provided with a hydraulic open system to keep open. Then the people are directly transferred in the building to the slideway, or moved to a secure fire zone by means of a platform, which is named the starting point A. Some floors are dropped in the slideway and do not pass the point A, the destination point is at a relatively lower level B. Then people move to a new starting point in the same level which is deems as the point A, and subsequently moves to another point which is deemed as the point B. This process will be repeated for several times, depending on the number of floor and slideway group. The internal slideway is designed with the building. According to the design of the invention, the slideway should have no ladder stand. However, during the transit process, the slideway goes from A to B inside the building. Except of an external type, the evacuation exit of the invention is arranged on a ladder stand formed by concrete or stainless steel, the ladder stand is based on solid fences and solid basements formed by concrete or stainless steel. The ladder stand should be reinforced from the top of outside to prevent collapse. The evacuation process is not necessary to be arranged with the building. By means of the ladder stand, people are transferred from the point A to B, and the evacuation exit will be separated from the fire zone. At the same time, in both external type and internal type, the ladder stand is provided with a coating to surround the ladder stand and the slideway in an external direction, in order to provide safety, protection and aesthetics. The ladder stand is connected to a circular or elliptical one ore more slideways. A bottom portion with a curved shape of the spiral slideway is used. At the same time, the internal surface of slideway is smooth, and is formed by a stainless material which is heat and environment resistant. The internal surface may be circular, elliptical, spiral, or the like. The slideway further has a type of the material by which the internal surface of the slideway is formed, and a down-bending angle determined by the weight of a person who may evacuate through the slideway. The slideway may have a circular, elliptical, or spiral spring-like shape, and bends downwards according to the floor height. Each end of slideway bends at a height of 20-30 cm over the ground, so that the exit of slideway is parallel with the ground to safely control the decline process. More than one slideway may be arranged on a single ladder stand. The present invention is characterized in that it can be operated manually, in which the casing of an alarm device is crushed, the smoke detector is caused to operate, since it will send a signal to the controller or the control room, which may send many signals, comprising a signal to the emergency lamp, a signal to the alarm device, a signal to the magnetic lock, and a signal to the alarm lamp. The rapid escape exit of the invention, i.e., the fifth mode Ashwan exit, is characterized in that the system is further provided with a backup battery, the operation of which may prevent power outrage. The invention is characterized in that it can be simply and easily connected to the alarm system. The rapid escape exit of the invention, i.e., the fifth mode of Ashwan exit intends to evacuate all people in a short time in a simple and fast manner, so that no life is in danger.

### BRIEF DESCRIPTION OF THE DRAWINGS

FIG. 1 is a structural view showing each escape exit in the rapid escape exit according to the present invention;

FIG. 2 is a schematic view showing one of the evacuation routes in the rapid escape exit according to the present invention;

FIG. 3 is a structural view showing the rapid escape exit according to the present invention which comprises two groups; and

FIG. 4 is a structural view showing the rapid escape exit according to the present invention which comprises more than two groups.

### DETAILED DESCRIPTION OF THE EMBODIMENTS

The specific implementations of the present invention will be further described hereinafter with reference to the drawings and embodiments. The following embodiments only intend to illustrate the technical solutions of the present invention more clearly, but do not intend to restrict the protection scope of the present invention.

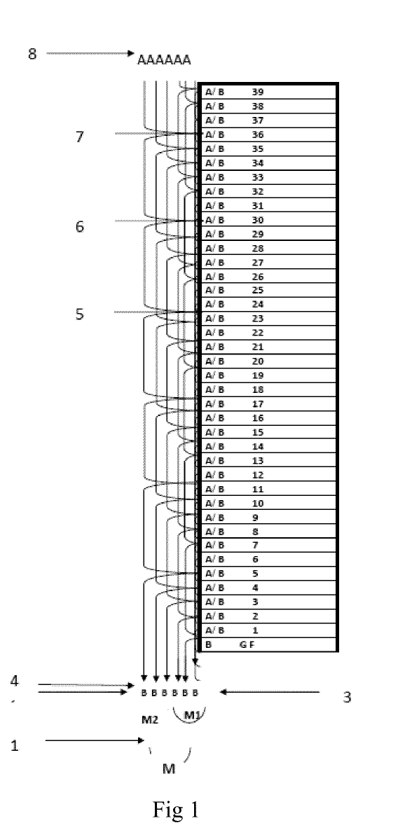

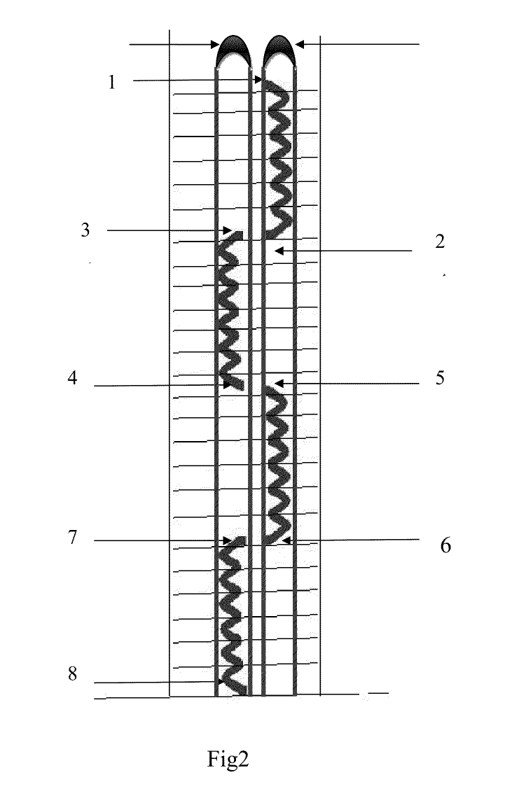

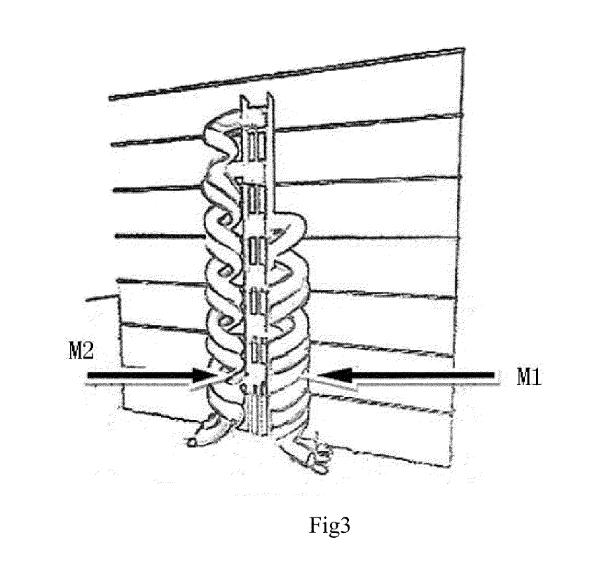

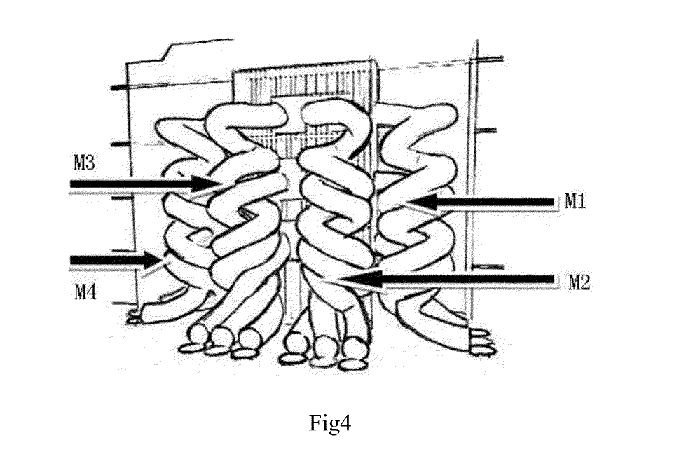

As shown in FIGS. 1-4, the present invention relates to a rapid escape exit for a building, i.e., the fifth mode of Ashwan exit. The primary concept of the rapid escape exit of the invention, i.e., the fifth mode of Ashwan exit, will be discussed hereinafter in detail. For example, the point 1 in FIG. 1 is a partial portion 1, and the point 4 in FIG. 2 is a partial portion 4. Some other features will be disclosed, for example the running features described above, features of easy to use and increasing aesthetic value for the building. This depends on the Ashwan evacuation rule, which defines B=A−M. A implementing design of the fifth mode will be taken as an embodiment, for example the rapid exit composed of two groups m₁ and m₂ shown in FIG. 2. In each figure apart from FIG. 4, each group is composed of three slideways. In FIG. 4, it is designed to be composed by four groups, and each group is composed of three slideways. The number of groups and the number of slideway composing the exit may be controlled according to possible demand during use. FIG. 1 is a side view of an embodiment for a building with 40 floors. The rapid escape exit of the invention, i.e., the fifth mode of Ashwan exit, may be applied to a building with hundreds of floors. The point 8 in FIG. 1 is a partial portion 8, in which all of A is the starting point of the evacuation process or a starting point for one of the evacuation period. This starting point is the exit in a dangerous floor, and slides down in the slideway in a spiral manner by means of the circular or spiral shaped regular group in FIGS. 3-4. Each starting point for sliding has a door, and is ended with another door. The exit may be operated automatically or manually as described above. It is also possible to arrange a ladder stand outside the building, so as to complete the transit period. These slideways determine and provide the operating route of the evacuation process. The overlapping homogeneous path and regular path are named the first path, second path, third path, and so on. The number of path is the number of slideway in a group, i.e., M. Each path is a regular structure between paths shown in FIG. 2. The point 7 in FIG. 1 is a partial portion 7, the point 5 in FIG. 1 is a partial portion 5, and the point 5 in FIG. 1 is the transit point which is inserted by the rule. The evacuation process may be performed in many periods. Starting from the point 8 (partial portion 8) in FIG. 1 as the point A, the process ends at the point 7 at the 36th floor in FIG. 1 as the point B. The point A in the 36th floor is a starting point of a new period of the evacuation. The point 7 in FIG. 1 indicates a partial portion 7, in which many floors have been passed. M=A−B=36−30=6, and this is the number of regular path or the number of slideway in all groups. The destination point is B. According to the rule, it can be seen that the destination point B=A−M, namely B=36−6=30. As a result, the destination point is 6 in FIG. 1 and is the 30th floor, and the point A in the 30th floor is the start of a new period. From the rule B=30−6=24, one can find that the destination point is 5 in FIG. 1 and is the 24th floor. The finish point of each period of all paths is the point B. For example, the point in FIG. 1 is the finish point in the first floor which equals to zero. Therefore, in the evacuation process, the first period starts from A and ends at B, and again starts from A which corresponds to B of the previous preiod. This process is also performed by a defined system, the moving process is systematized, and the system is added to the control panel of the existing fire extinguishing system. Here, the process is performed in a safe manner by turning on and off the starting point A, to prevent from descending to a dangerous floor. It is electronically controlled and it is used for the system which is connected to the smoke detector. Therefore, as we find, the evacuation is performed after detection of smoke and danger, or by virtue of crushing the alarm point which will open the door. At the same time, the light signal and the alarm device start to run. People enter the slideway through the exit point A, and the evacuation process will be performed. These slideways are made from a material with a smooth surface for sliding smoothly to reach the exit point in the slideway at the point B. These slideways are characterized in that the light emitting device and ventilation devices are systematically integrated in the slideway, and are further provided with a backup battery or other energy sources so as to maintain operation after power outrage. The slideway coordinates the sliding process, until the people reach the ground external to the building from which people evacuate. The bending angle of the slideway should be designed carefully, which is neither an acute angle to which people sliding fast may hit, nor an obtuse angle which may lead to suspension and congestion. The upper opening should bend upwards to the sideface and are arranged tightly to make it easy to deal with the suspended inside. As the evacuation process is complete, the controller is shut off to get ready for the next emergency situation. The operation manner of the rapid escape exit, i.e., the fifth mode of Ashwan exit, the subject matter of the present invention is believed to be apparent from the drawing the description mentioned above. Any modification to size, forming material, shape, component, fitting method, operating method, or method of use would be apparent for the skilled in the art.

1. A rapid escape exit for a high building, characterized in that, said escape exit is arranged between one floor and another floor inside and/or outside the high building, and between a floor and the ground, in said high building said escape exit is divided into several groups, in each group of escape exit is provided at least one spiral slideway, one end of said spiral slideway is provided at the escape exit of an escape starting floor, and the other end of said spiral slideway is provided at the escape exit of an intermediate floor during escape, said spiral slideway crosses several floors in the high building, several spiral slideways in said several groups make it possible for all people in the high building to escape in a relay evacuation manner, said relay evacuation is an evacuation in which the escape people come out from the escape exit of a spiral slideway, then enter the escape entrance of another spiral slideway, until they finally reach the ground.

2. The rapid escape exit for a high building according to claim 1, characterized in that, the internal surface of said spiral slideway is a smooth surface, and the cross-section of said spiral slideway is circular or elliptical.

3. The rapid escape exit for a high building according to claim 2, characterized in that, an exit end of said spiral slideway has a length which is parallel with the ground.

4. The rapid escape exit for a high building according to claim 1, characterized in that, said escape exit arranged outside the high building is supported by a ladder stand, and said ladder stand is provided with a platform and fences at the exit and entrance of each spiral slideway.

5. The rapid escape exit for a high building according to claim 4, characterized in that, a switch controlled escape door is arranged at the exit and entrance of each spiral slideway, and said escape door is connected with a controller.

6. The rapid escape exit for a high building according to claim 5, characterized in that, said controller drives said escape door with a hydraulic driving device, and said escape door is further provided with a magnetically controlled lock.

7. The rapid escape exit for a high building according to claim 6, characterized in that, an emergency lamp and an alarm device are further arranged inside said spiral slideway and at the exit and entrance.

8. The rapid escape exit for a high building according to claim 7, characterized in that, said controller, emergency lamp, and alarm device is powered by a storage battery or an uninterruptible power supply.
